(19) United States
(12) Patent Application Publication
(10) Pub. No.: US 2023/0289914 A1
(43) Pub. Date: Sep. 14, 2023

(54) Identifying, Quantifying, and Mitigating Risks within Agricultural Supply Chains

(71) Applicant: AON GLOBAL OPERATIONS SE, SINGAPORE BRANCH, Singapore (SG)

(72) Inventors: Craig Kiebler, Decatur, GA (US); Anna Coyle, Dublin (IE)

(73) Assignee: AON GLOBAL OPERATIONS SE, SINGAPORE BRANCH, Singapore (SG)

(21) Appl. No.: 18/198,641

(22) Filed: May 17, 2023

Related U.S. Application Data
(63) Continuation-in-part of application No. 17/747,885, filed on May 18, 2022, now abandoned.
(60) Provisional application No. 63/189,799, filed on May 18, 2021.

(51) Int. Cl. G06Q 50/28; G06Q 10/0635; G06Q 30/018; G06Q 10/0639

(52) U.S. Cl. CPC G06Q 50/28; G06Q 10/0635; G06Q 10/06393; G06Q 30/018

(57) ABSTRACT

In an illustrative embodiment, systems and methods using an agri-food risk tracking and management platform can provide risk mitigation in a food supply chain based on aggregated risk data for each of a set of suppliers in the food supply chain. Aggregate governance and compliance data may be aggregated for the set of suppliers, including data for each supplier relating to inspections, citations, and/or regulatory compliance. Ingredient risk factors may be determined, using trained data models, for supplier food product ingredient(s). The data models may be trained using industry food data, where the risk factors are determined based on historic food born illness data corresponding to attributes of the industry food data. Based on historical governance and compliance performance data, a governance and compliance score representing the relative performance of the set of suppliers may be determined.

### RELATED APPLICATIONS

This application is a continuation-in-part of and claims priority to U.S. Pat. Application Serial No. 17/747,885, entitled “Identifying, Quantifying, and Mitigating Risks within Agricultural Supply Chains,” filed May 18, 2022, which claims the benefit and priority to U.S. Provisional Pat. Application Serial No. 63/189,799, entitled “Identifying, Quantifying, and Mitigating Risks within Agricultural Supply Chains,” filed May 18, 2021. All above identified applications are hereby incorporated by reference in their entireties.

### BACKGROUND

The food industry faces a myriad of challenges - the convergence of product and supply chain complexity, growing regulatory and public health pressures, changing consumer demands, and rapid technological advances - that continue to evolve.

Small and middle market (SME) food suppliers face competitive challenges from size and revenue constraints, often struggling to meet regulatory and customer food safety requirements. A single contamination event can have business-threatening consequences for these companies, and many lack access to affordable insurance that includes appropriate third-party coverage.

By contrast, larger food companies have dedicated food safety teams with substantial systems to mitigate risk, but limited ability to quantify and visualize risk across their supply chain. While they have access to product contamination coverage through the traditional insurance market, they remain exposed to contamination originating in their supply chain and often take financial liability.

The inventors identified a need for enabling both food companies and their suppliers to better understand critical threats, explore methods to control these risks, and identify products and/or services to protect against potential business-threatening financial and reputational liabilities.

### SUMMARY OF ILLUSTRATIVE EMBODIMENTS

The foregoing general description of the illustrative implementations and the following detailed description thereof are merely exemplary aspects of the teachings of this disclosure and are not restrictive.

In one aspect, the present disclosure relates to a platform configured to capture data from the entire ecosystem of US federally-regulated companies and link dozens of disparate data sets to a company profile. The company profiles may involve many steps within the supply chain, such as food companies / manufacturers, contract manufacturers servicing food companies, and food producers (e.g., manufacturing sites).

In some embodiments, the platform uses advanced analytics to extract insights from the collected data. The analytics, in some examples, may include statistical analysis, machine learning, artificial intelligence, and analytical forecasting across data collected from disparate sources. The insights, for example, may be presented to a user (e.g., representative of one of the companies) to support the user in proactive risk selection and avoidance of risk aggregation. The presentation, for example, may include an interactive graphical user interface identifying risks in one or more areas. The risks may be presented in view of industry-wide risk analysis. In an illustrative example, risk may be assessed across a number of segments to provide data-derived insights, such as a governance and compliance segment, a contamination insurance segment, an operations and stability segment, a sourcing segment, a defects and contamination segment, and a products segment.

In some embodiments, the platform supports intake of supply chain information from clients. For example, the platform may provide a graphical user interface for user submission of supplier information. The supplier information, in turn, may be analyzed by the platform to generate supply chain insights for client review. The supply chain insights may be presented in an interactive graphical user interface. The interactive graphical user interface, for example, may identify risks at each stage within at least a portion of a client’s supply chain. The supply chain, for example, may be modeled to readily identify a “weakest link” in risk analysis and/or to demonstrate compounded risk incurred through links between suppliers within the client’s supply chain. In a further example, the presentation may include an interactive graphical user interface for comparing supplier performance of multiple suppliers across one or more risk categories. This presentation, for example, may be used by a client to support selection of a supplier meeting the client’s risk appetite and/or to support decision-making in whether to switch to a new supplier.

In some embodiments, data analytics derived by the platform supports intuitive, risk-based underwriting for product contamination insurance coverage. Using the insights provided by the platform, for example, insurers may establish an affordable, risk-based pricing model. The pricing model, for example, may reward companies having risk-mitigated supply chains with lower premiums. In one example, the pricing model may couple current industry pricing with quantitative risk assessments provided by the platform’s data analytics, enabling a more granular deconstruction of a company’s risks and identification of key drivers for those risks. This coupling results in superior risk analysis precision.

In some embodiments, the platform includes an insurance application pre-populated with underwriting data based on the data analytics as well as the information collected regarding the companies through aggregating data from the disparate data sources. This pre-population, for example, supports streamlining of the submission/quote/bind process. In some implementations, underwriting may be automated at least in part through analysis of the pre-populated underwriting data.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1 illustrates a block diagram of an example system and environment for agri-food risk tracking and management;

FIG. 2A and FIG. 2B illustrate a flow diagram of an example process for analyzing governance and compliance data and generating objective risk metrics;

FIG. 2C illustrates a screen shot of an example user interface for reviewing governance and compliance data metrics;

FIG. 2D illustrates a screen shot of an example user interface for reviewing inspection data metrics;

FIG. 3A illustrates a flow diagram of an example process for analyzing recall data and generating defects and contamination risk metrics;

FIGS. 3B through 3D illustrate screen shots of example user interfaces for reviewing recall data metrics;

FIG. 4 illustrates a flow diagram of an example process for analyzing food illness outbreak data and generating objective outbreak severity metrics;

FIG. 5 illustrates a flow diagram of an example process for applying agri-food risk analytics to agri-food contamination insurance coverage pricing;

FIG. 6A illustrates a screen shot of an example user interface for reviewing risk aspects of a supplier in view of industry benchmarks and target levels of risk exposure;

FIG. 6B illustrates a flow chart of an example method for identifying supplier peers and preparing a peer risk comparison of agri-food risk metrics;

FIG. 7 is a flow diagram of an example process for analyzing operations data and generating objective operations safety and stability metrics; and

FIG. 8 is a flow diagram of an example process for analyzing import refusals data and generating objective product sourcing metrics.

### DETAILED DESCRIPTION OF ILLUSTRATIVE EMBODIMENTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

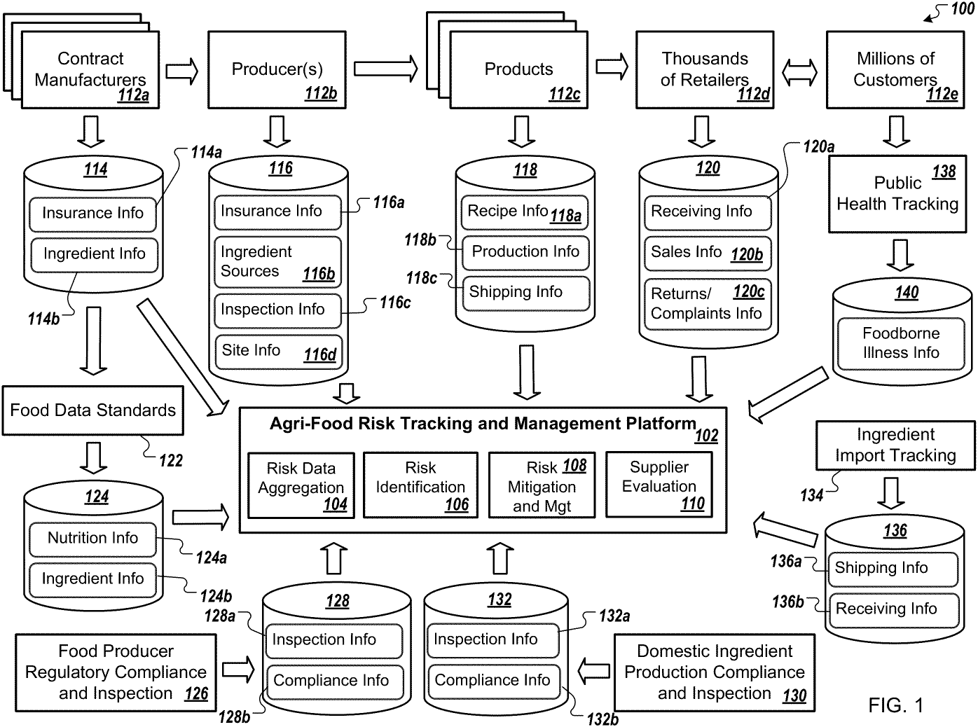

FIG. 1 illustrates a block diagram of an example system and environment 100 including an agri-food risk tracking and management platform 102 for providing risk data aggregation tools 104, risk identification tools 106, risk management and mitigation tools 108, and supplier evaluation tools 110 regarding various stages of a supply chain 112. The supply chain 112 may include multiple contract manufacturers 112a each contracting for edible goods from one or more producers 112b. The producer(s) 112b, in turn, create products 112c to be shipped to retailers 112d for purchase by customers 112e.

In some embodiments, the risk data aggregation tools 104 of the agri-food risk tracking and management platform 102 import data from each of the various stages of the supply chain 112. Each contract manufacturer 112a, for example, may supply contract manufacturer data 114 such as, in some examples, insurance information 114a demonstrating contamination insurance coverage and/or ingredient information 114b regarding ingredients for one or more of their products 112c, as well as identification of one or more producers 112b producing product for the contract manufacturers 112a. Each producer 112b may supply producer data 116 such as, in some examples, insurance information 116a demonstrating contamination insurance coverage, ingredient source information 116b regarding one or more suppliers of ingredients for the producers 112b, site information 116d identifying one or more manufacturing sites for each producer 112b, and/or inspection information 116c regarding inspections of one or more manufacturing sites of each producer 112b. The producers 112b may also supply product data 118 including recipe information 118a, production information 118b regarding production schedules and corresponding product identifiers, and/or shipping information 118c regarding the retailers 112d to which the products 112c have been delivered. Conversely, retailers 112d may supply retailer data 120 including receiving information 120a identifying receipt of the products 112c from the producers 112b. The retailer data 120 may further include sales information 120b regarding sales of the products 112c and returns and/or complaints information 120c regarding problems the customers 112e identified with one or more of the products 112c. The agri-food risk tracking and management platform 102 may correlate the various data sources 114, 116, 118, and/or 120 using risk data aggregation tools 104 and then analyze the data 114, 116, 118, and/or 120 using risk identification tools 106.

In some embodiments, in addition to or in lieu of receiving data directly from the entities involved in the supply chain 112, the agri-food risk tracking and management platform 102 obtains certain data from third party organizations. For example, one or more food data standards organizations 122, such as the Global Branded Food Products Database, the Center for Food Safety and Applied Nutrition (CFSAN), and/or the Food and Drug Administration (FDA), may provide food data 124, such as ingredient information 124a (e.g., supplementing and/or in lieu of ingredient information 124b, recipe information 118a, etc.) and/or nutrition information 124b, to the platform 102. One or more food producer regulatory compliance and inspection organizations 126, such as the FDA and/or one or more state-level regulatory organizations, may supply regulatory data 128 to the platform 102, such as inspection information 128a (e.g., supplementing and/or in lieu of inspection information 116c) and/or compliance information 128b. Similarly, one or more domestic ingredient production compliance and inspection organizations 130, such as the United States Department of Agriculture (USDA), may supply compliance data 132 to the platform 102, such as inspection information 132a and/or compliance information 132b. For ingredients produced outside of the subject geographic region, in another example, one or more ingredient import tracking organizations 134, such as Cooperative Interstate Shipment (CIS) Establishments and/or the FDA, may provide import data 136, such as shipping information 136a and/or receiving information 136b, regarding ingredients imported from other geographic regions (e.g., supplementing and/or in lieu of ingredient information 114b, ingredient sources 116b, etc.). To track food contamination events using the agri-food risk tracking and management platform 102, in another example, one or more public health tracking organizations 138, such as regional departments of health and human services (DHHS), the national Center for Disease Control (CDC), and/or the Interagency Food Safety Analytics Collaboration (IFSAC), may provide foodborne illness data 140 to the platform 102.

In some embodiments, one or more risk identification tools 106 are configured to identify potential risk associated with the one or more stages of the supply chain 112. The risk identification tools 106, for example, may confirm application of best practices across one or more of the stages of the supply chain 112. For example, the risk identification tools 106 may confirm compliance with inspection schedules and/or sufficiency of contamination insurance coverage. Further, the risk identification tools 106 may identify non-compliance issues within the inspection information 116c, the inspection information 128a, the inspection information 132a, the compliance information 128b, and/or the compliance information 132b. The compliance information 128b, for example, may differ from the compliance information 132b in including Occupational Safety and Health Administration (OSHA) regulatory compliance information for manufacturers. The non-compliance issues, for example, may be further weighed by relative severity. In an illustrative example, a class 1 non-compliance issue may expose consumers to immediate harm (e.g., foodborne illness outbreak, contamination with foreign substance, cross-contamination with common allergen), a class 2 non-compliance issue may expose consumers to some harm (e.g., potential ingredient cross-contamination and/or failure to list one or more ingredients), and a class 3 non-compliance issue may cause no real harm to consumers (e.g., an error in labeling that does not impact allergies, etc.). In another example, the risk identification tools 106 may analyze the compliance information 128b for evidence of repeated violations and/or patterns of violations.

In some implementations, the risk identification tools 106 identify foodborne illness risk related to inspection information 116c, production information 118b, and/or shipping information 118c relative to various governmental standards. For example, the risk identification tools 106 may analyze inspection information 116c, production information 118b, and/or shipping information 118c in view of Occupational Safety and Health Administration (OSHA) standards related to foodborne disease.

In some implementations, the risk identification tools 106 identify foodborne illness risk related to ingredients. For example, the food and drug administration (FDA) includes a risk ranking model related to ingredients. The risk identification tools 106 may identify ingredients and/or ingredient combinations exposing the supply chain 112 to additional risk. Further, the risk identification tools 106 may identify commodities, such as categories of food product, corresponding to increased risk. The risk identification tools 106 may combine risk models from two or more regulatory bodies to create an enhanced ingredient and/or commodity risk model.

In some implementations, the risk identification tools 106 include one or more machine learning analysis engines for identifying correlations between data provided by contract manufacturers 112a and/or producers 112b and increased risk. The correlations, for example, may be made between ingredients 114b, ingredient sources 116b, production information 118b, and/or shipping information 118c and related foodborne illness outbreaks (e.g., based on compliance information 128b/132b and/or foodborne illness information 140). The machine learning analysis engines, in some illustrative examples, may supplement ingredient risk models, such as the FDA model, with additionally identified ingredient risk, identify one or more supply chain practices corresponding to increased risk, and/or identify one or more production practices corresponding to increased risk.

In some implementations, the risk management and mitigation tools 108 identify potential risk areas and provide suggestions for mitigating or avoiding the risk. The risk management and mitigation tools 108, for example, may include pricing tools for appropriately pricing insurance based upon calculated entity risk within subject supply chains. Further, the risk management and mitigation tools 108 may include identification of a “weakest link” in a supply chain (e.g., worst scoring producer 112b) and recommend removal or replacement of the problem supplier. In another example, the risk management and mitigation tools 108 may identify a shipping problem (e.g., temperature abuse) that could be resolved by adjusting shipping, adjusting production, and/or adjusting recipe.

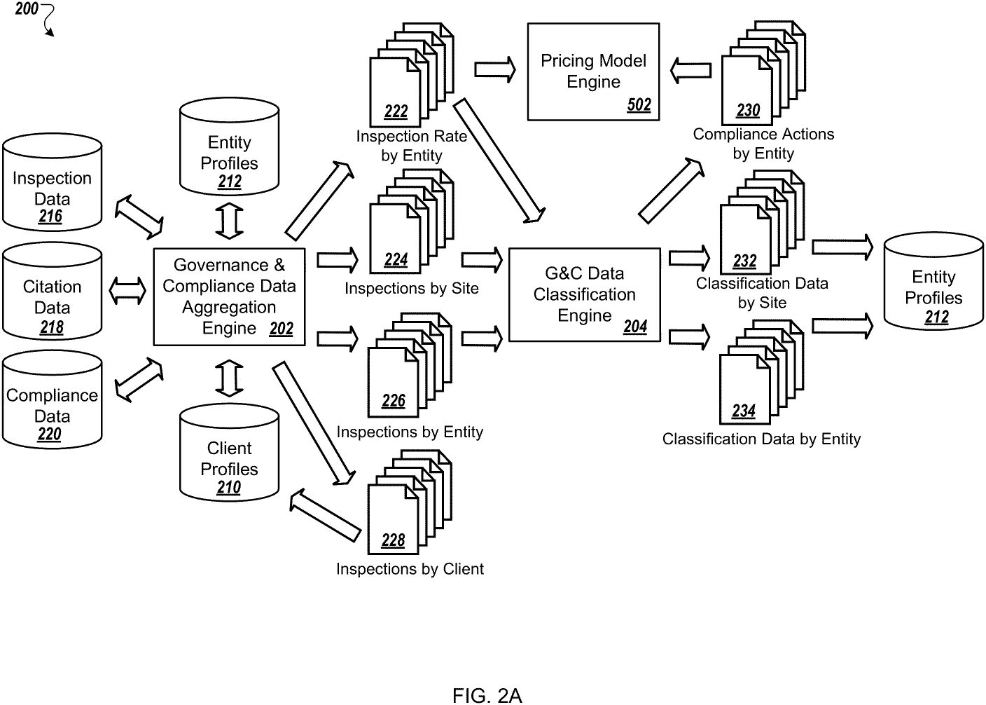

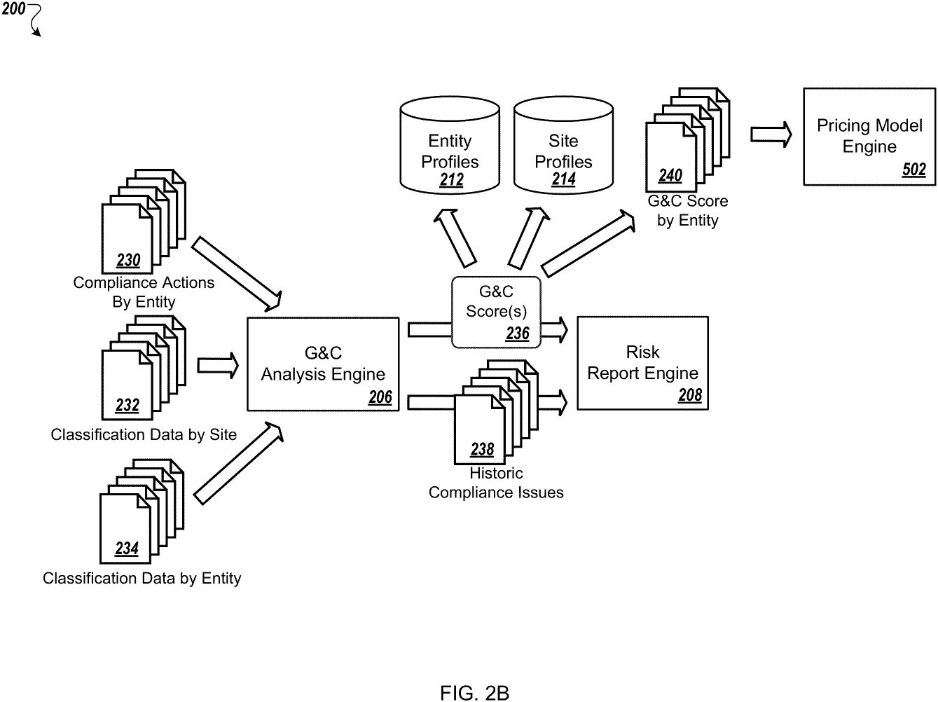

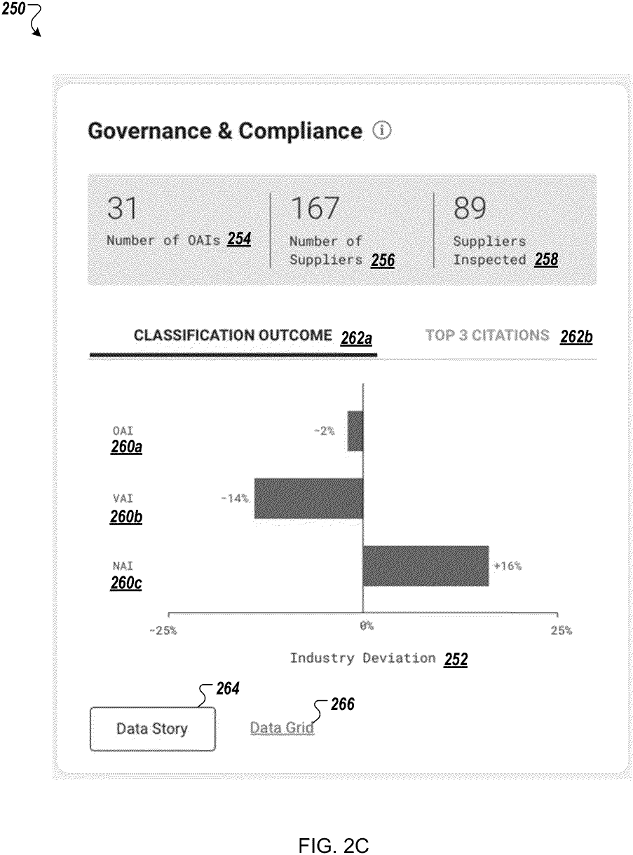

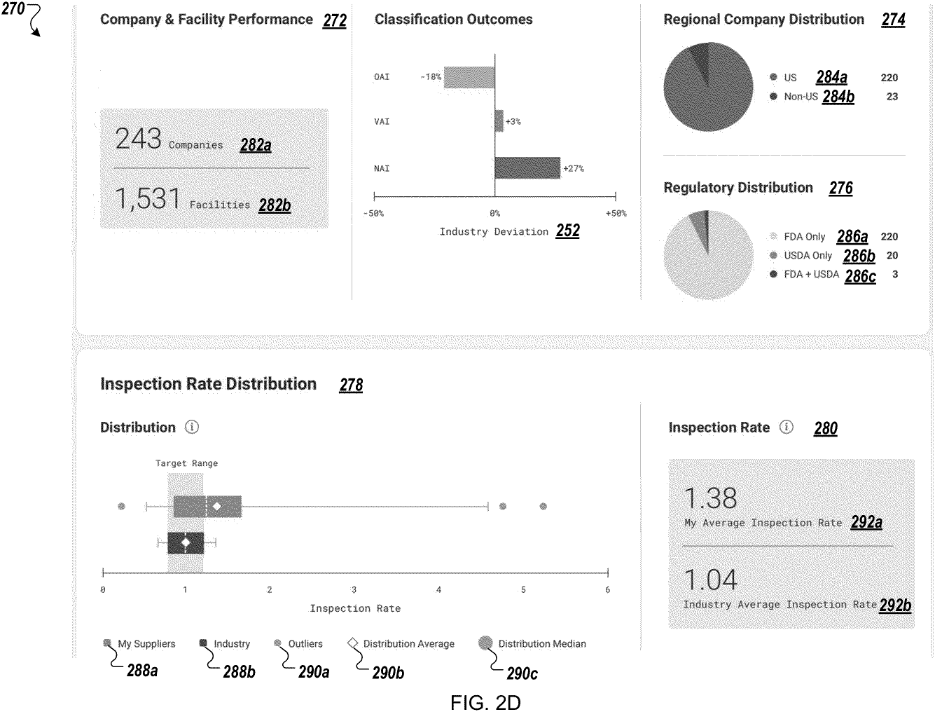

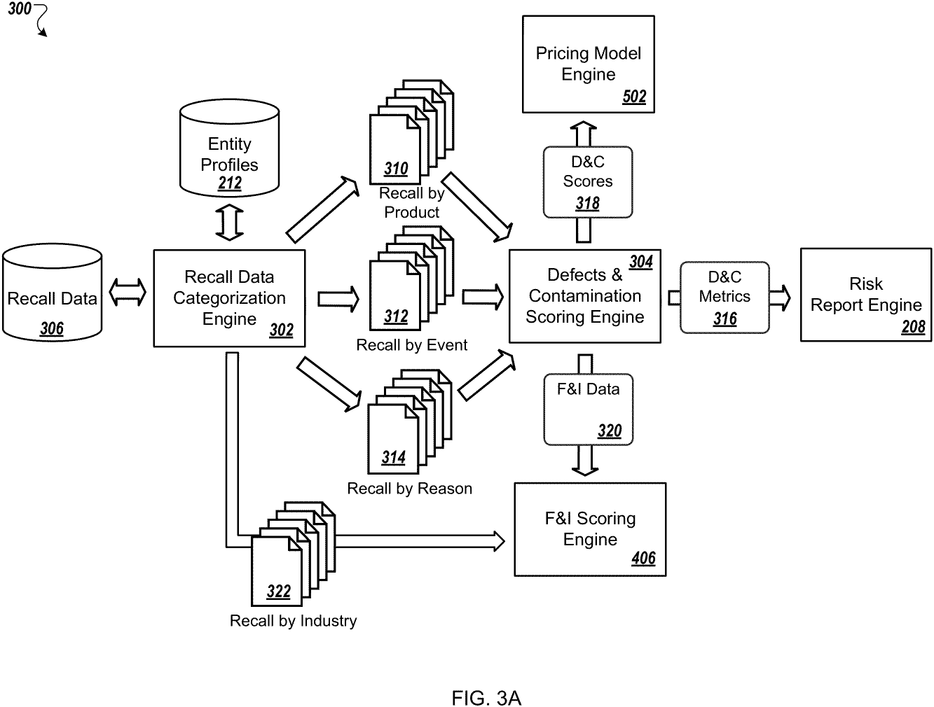

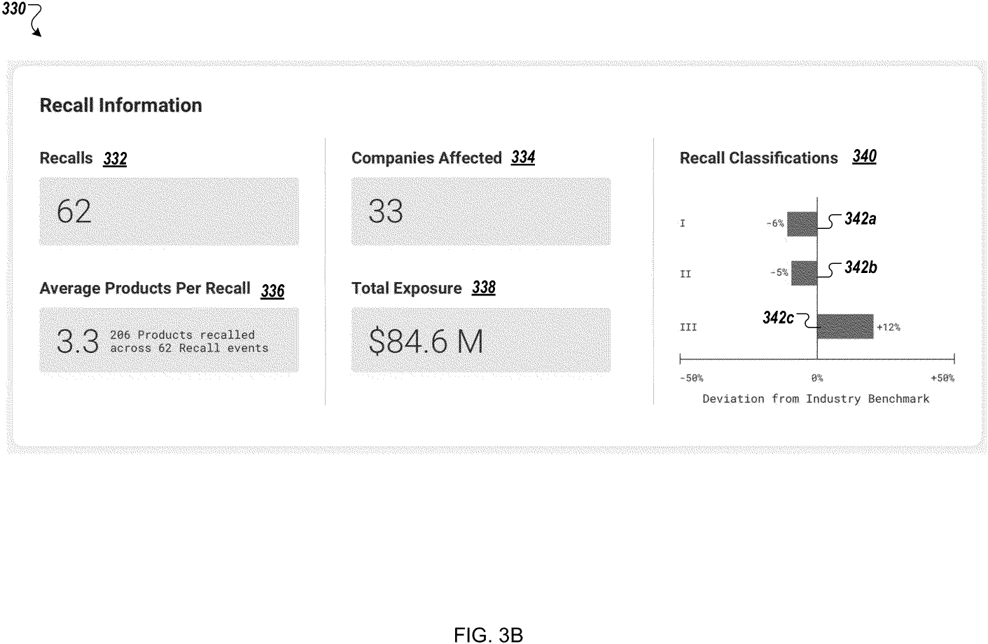

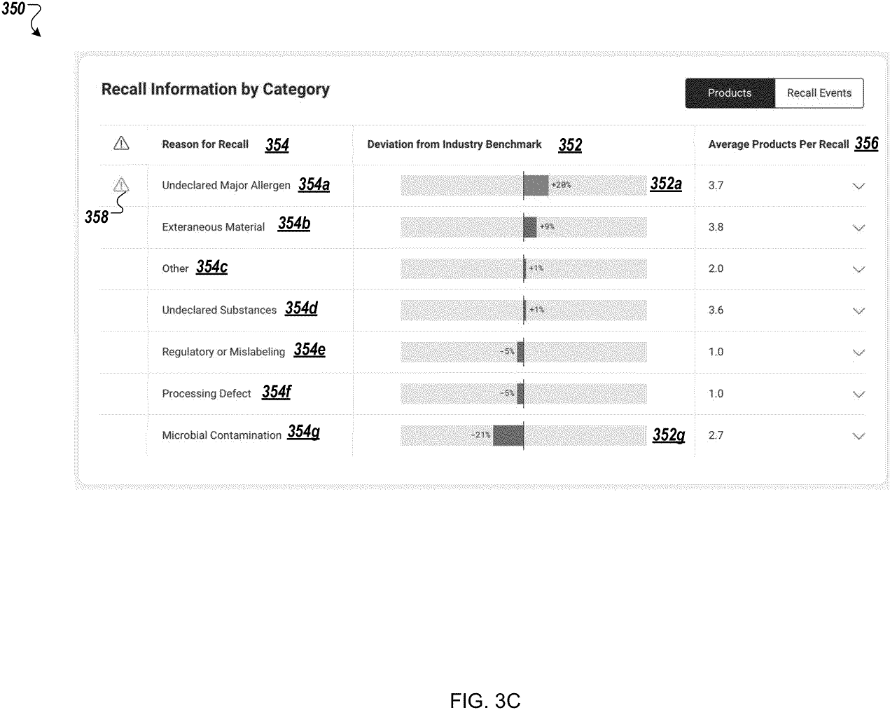

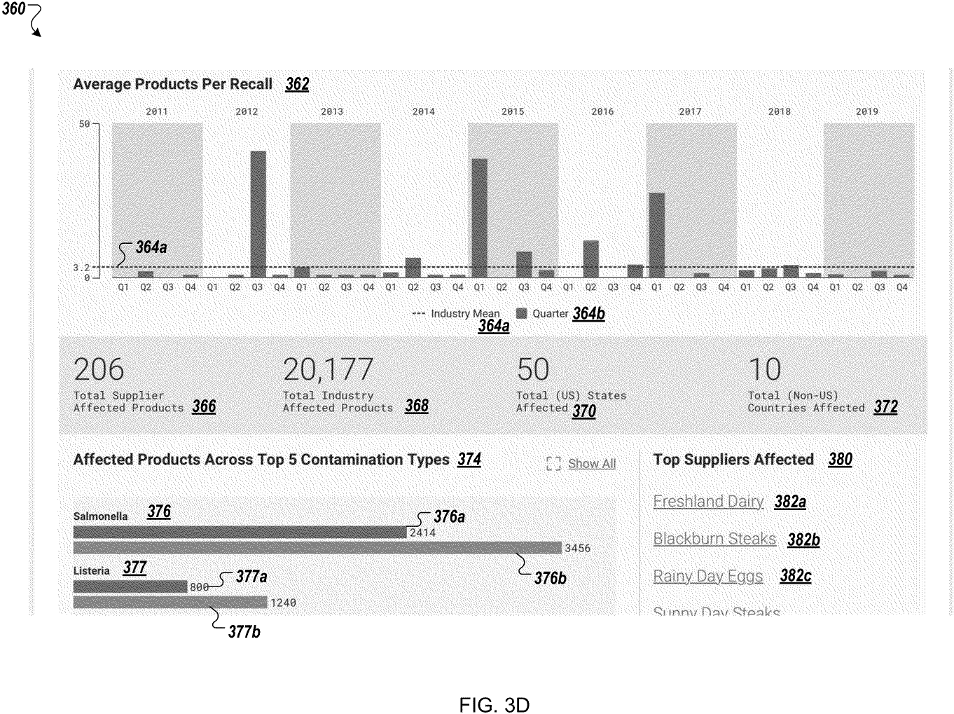

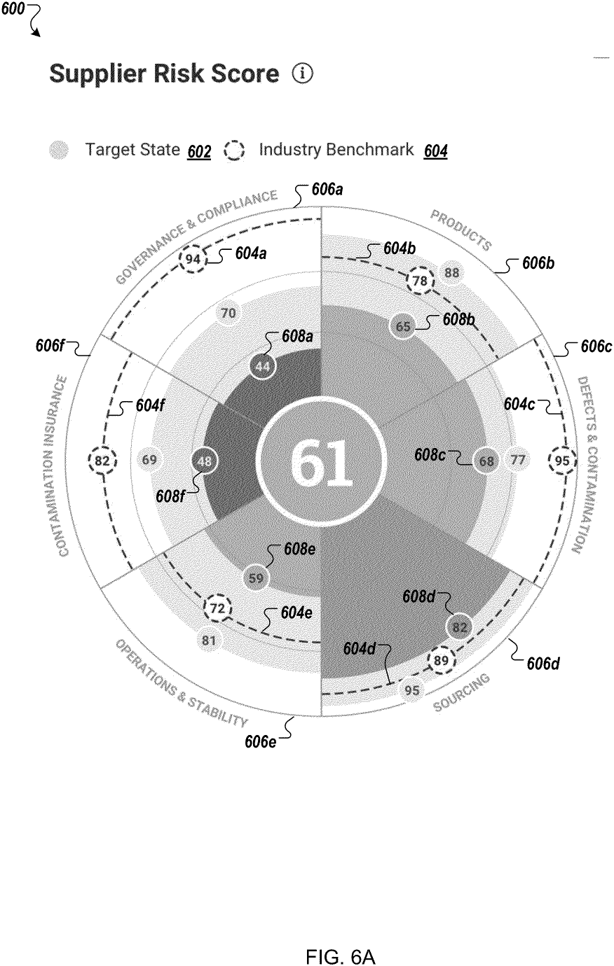

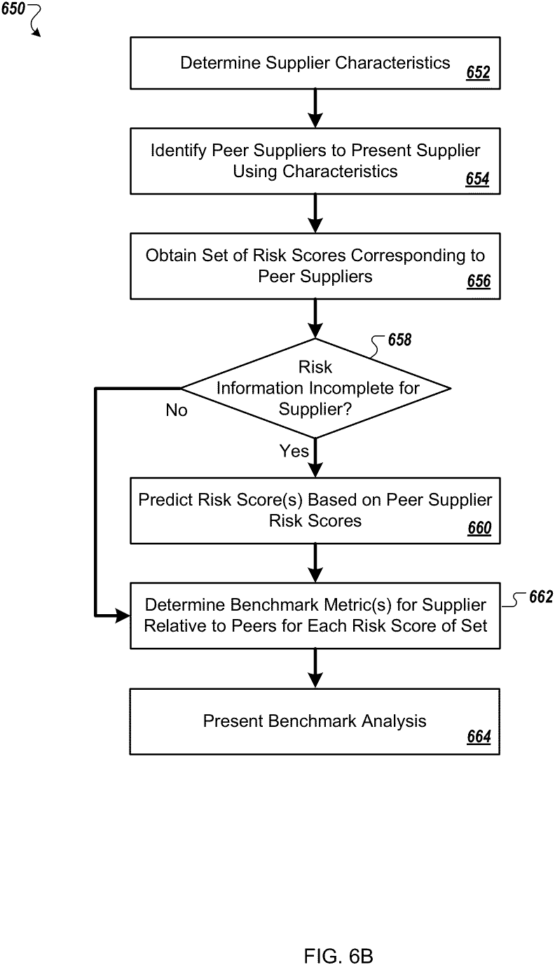

In some implementations, the supplier evaluation tools 110 provide information to entities including suppliers, such as the contract manufacturers 112a and/or producers 112b, and organizations having multiple suppliers. The risk management and mitigation tools 108 may compare the suppliers to industry norms and identify deviations therefrom. The risk management and mitigation tools 108, for example, may provide the supplier risk score information as illustrated in FIG. 6A. Similar risk analysis may be presented, for example, in relation to a subject supplier through reviewing data related to each of the risk areas 606a-606f. The risk information, for example, may be similar to that presented in relation to an entity view of multiple suppliers as presented in relation to FIG. 2C, FIG. 2D, and FIG. 3B-FIG. 3D.

FIG. 2A and FIG. 2B illustrate a flow diagram of an example process 200 for analyzing governance and compliance data and generating objective risk metrics. The process 200 may be performed by the agri-food risk tracking and management platform 102 of FIG. 1. For example, data received by the process 200 may be aggregated, classified, and linked with further information by risk data aggregation tools 104 prior to analysis by one or more risk identification tools 106. The data analysis conducted by the process 200 may produce metrics, comparisons, forecasts, and/or other information utilized by one or more risk management and mitigation tools 108.

Turning to FIG. 2A, in some embodiments, a governance and compliance (G&C) data aggregation engine 202 receives inspection data 216, citation data 218, and compliance data 220 regarding supplier inspections and/or regulatory approvals. The inspection data 216, citation data 218, and/or compliance data 220, in some examples, may have been obtained from one or more producers 112b, food producer regulatory compliance and inspection organizations 126, and/or domestic ingredient production compliance and inspection organizations 130, as described in relation to FIG. 1. Further, the G&C data aggregation engine 202 may obtain entity profiles 212 regarding the suppliers. The entity profiles 212, for example, may correlate producers 112b with one or more sites, as described in relation to FIG. 1. The entity profiles 212, in some implementations, further include at least a portion of the inspection data 216, citation data 218, and/or compliance data 220 (e.g., as provided to the agri-food risk tracking and management platform 102 of FIG. 1 by the producers 112b). In some implementations, clients (e.g., end users) of the agri-food risk tracking and management platform 102 of FIG. 1, represented by client profiles 210, may provide client inspection data 228 to the G&C data aggregation engine 202. The G&C data aggregation engine 202, for example, may import data and/or access data from storage regions maintained by the agri-food risk tracking and management platform 102 of FIG. 1.

The G&C data aggregation engine 202, in some embodiments, aggregates the data from the various data sources 212, 216, 218, 220, and/or 228 to produce aggregated data sets such as inspection rate by entity data 222, inspections by site data 224, inspections by entity data 226, and/or at least a portion of the inspections by client data 228. The data aggregated by the G&C data aggregation engine 202 may represent, in some examples, entities involved in the supply chain of a subject contract manufacturer 112a, entities involved in the supply chain of a subject producer 112b, data associated with a certain producer 112b, data involving all producers 112b of the environment 100, data involving all contract manufacturers 112a of the environment 100, and/or data involving all supply chains 112 of the environment 100 of FIG. 1. The G&C data aggregation engine 202, in some examples, may be executed upon receipt of data recently uploaded to the environment 100 of FIG. 1, on a periodic basis, and/or upon request by a client of the environment 100 submitted to one of the risk management and mitigation tools 108 and/or the supplier evaluation tools 110.

In some embodiments, the aggregated data sets 222, 224, and 226 are provided to a G&C data classification engine 204 for classifying the data. Classifications, in some examples, may be performed in relation to inspection outcomes (e.g., official action indicated (OAI), voluntary action indicated (VAI), no action indicated (NAI), etc.), citation types, citation severities, inspection frequencies, and/or outbreak frequencies. As illustrated, the G&C data classification engine 204 may group the classified data as classification data by site 232 and/or classification data by entity 234. The classification data 232, 234 may be stored in relation to each entity profile 212, for example, in a database, data network, or other data store maintained by the agri-food risk tracking and management platform 102 of FIG. 1.

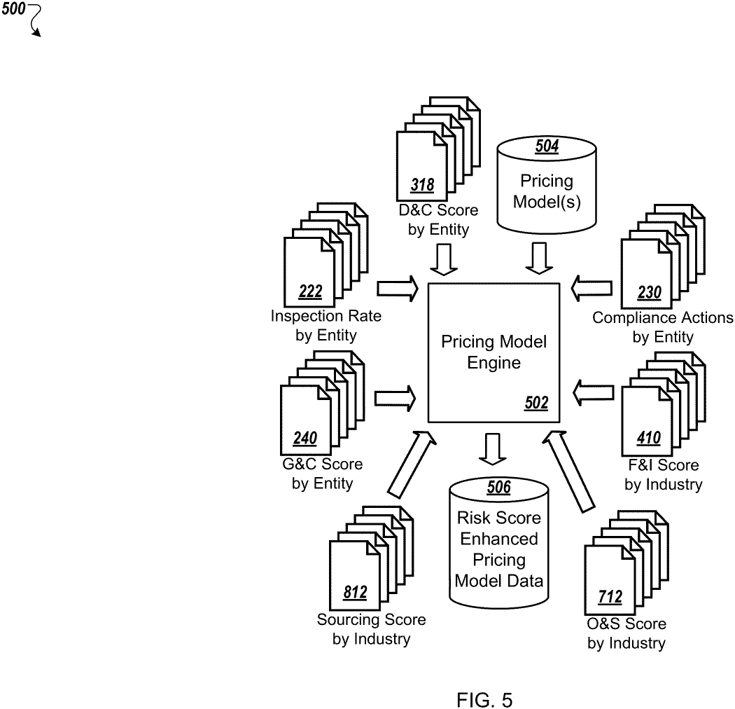

In some implementations, the G&C data classification engine 204 also classifies compliance actions taken by entities as compliance actions by entities 230. The compliance actions, for example, may be obtained from the compliance data 220 and/or via voluntary actions and/or official actions identified in the inspection data 216 and/or citation data 218. The compliance actions by entity 230 may be provided to a pricing model engine 502, described in relation to FIG. 5, to generate a risk-based contamination insurance coverage pricing model. The pricing model engine 502 may further receive the inspection rate by entity data 222 generated by the G&C data aggregation engine 202.

Turning to FIG. 2B, in some embodiments, the process 200 continues with a G&C analysis engine 206 receiving the compliance actions by entity data 230, the classification data by site 232, and the classification data by entity 234. The G&C analysis engine 206 may analyze the data sets 230, 232, and 234 to determine governance and compliance scores 236 for each entity and/or site. The G&C scores 236, for example, may identify relative performance against other entities and/or sites evaluated by the agri-food risk tracking and management platform 102. The G&C scores 236, in some examples, may include rankings, distributions (percentiles, quartiles, etc.), variances from a median or average, variances from a target (e.g., system target or client-specified target), and/or ratings (e.g., excellent, good, standard, bad, etc.). The G&C scores 236 may be stored to the entity profiles 212 and/or site profiles 214 of the corresponding entities and/or sites.

In some implementations, the G&C scores 236 are provided as a G&C scores by entity (and/or by site) data set 240 to the pricing model engine 502, described in relation to FIG. 5.

In some embodiments, the G&C scores 236 are supplied to a risk report engine 208 for generating information for review by one or more users of the agri-food risk tracking and management platform 102 of FIG. 1. The risk report engine 208, for example, may translate the G&C scores 236 into graphs, lists, tables, diagrams, and/or other analysis. The analysis may be provided in a document or email. In another example, the analysis may be provided in an interactive graphical user interface, such as a client portal to the agri-food risk tracking and management platform 102 of FIG. 1. In addition to the G&C scores 236, in some embodiments, the risk report engine 208 receives historic compliance issues 238 related to one or more of the entities and/or sites. The historic compliance issues, for example, may be provided in a drill-down analysis of individual suppliers to identify particular concerns related to the supplier (e.g., one of the contract manufacturers 112a and/or producers 112b of a client of the platform 102) within an interactive graphical user interface. The risk report engine 208, for example, may generate a report including the screen shots illustrated in FIG. 2C and FIG. 2D.

Turning to FIG. 2C, a screen shot of an example governance & compliance user interface 250 for reviewing governance and compliance data metrics and trends is presented. The user interface 250 includes an industry deviation bar graph 252 of an active classification outcome tab 262a illustrating industry deviations (e.g., across 89 inspected suppliers 258 of 167 total suppliers 256) across inspection outcomes 260 (e.g., OAI 260a, VAI 260b, NAI 260c). The example user interface 250 also illustrates that a total number of OAI inspection outcomes 254 was 31. An unselected tab 262b provides information on a top 3 citations of the inspected suppliers 258.

In some implementations, a data story control 264, when selected, provides a graphical representation of facts such as the information presented in FIG. 2D. Turning to FIG. 2D, a screen shot of an example user interface 270 for reviewing inspection data metrics is illustrated. In addition to the industry deviation graph 252 of FIG. 2C, the example screen shot 270 includes a summary 272 include a listing of (243) total companies 282a and (1,531) total facilities 282b analyzed. Within those totals, a regional company distribution graph 274 identifies that 220 of the companies 282a were in the United States 284a and 23 of the companies 282a were not in the United States 284b. A regulatory distribution graph 276 presents a breakdown in regulatory schemes by company, including FDA only 286a (220), USDA only 286b (20), and both FDA and USDA 286c (3).

In a lower portion of the example screen shot 270, an inspection rate distribution graph 278 illustrates “my suppliers” inspection rate distribution 288a (e.g., suppliers within an entity’s supply chain(s)) in relation to an industry inspection rate distribution 288b (e.g., all companies 282a or a portion of the companies 282a involved in a same industry). Additionally, an inspection rate summary 280 identifies that the “my suppliers” 288a have an average inspection rate 292a of 1.38, while the industry 288b has an average inspection rate 292b. Additional markers identify outliers 290a, a distribution average 290b for each of the suppliers 288a and the industry 288b, as well as a distribution median 290c.

Returning to FIG. 2C, in some implementations, a data grid control 266, when selected, presents a more detailed, or “raw”, statistical analysis beyond the information presented in FIG. 2C. The data grid may include, in some examples, identifications of the individual suppliers, parent organizations of those suppliers, individual supplier scores, a number of official actions per supplier, and/or a link to the FDA history for each individual supplier.

FIG. 3A illustrates a flow diagram of an example process 300 for analyzing recall data and generating defects and contamination risk metrics. The process 300, for example, may obtain recall data 306 from the public health tracking data source(s) 138, the domestic ingredient production compliance and inspection data source(s) 130, and/or the food producer regulatory compliance and inspection source(s) 126 of FIG. 1. Portions of the example process 300, for example, may be performed by one or more risk identification tools 106, and/or risk management and mitigation tools 108 of the agri-food risk tracking and management platform 102 of FIG. 1.

In some embodiments, a recall data categorization engine 302 obtains the recall data 306 from two or more separate sources, such as both FDA and USDA recall data, and aggregates the recall data 306 from the various data sources to produce aggregated data sets such a recall by product data set 310, a recall by event data set 312, a recall by reason data set 314, and/or a recall by industry data set 322. Certain data sets, such as the recall by industry data set 322, may include information derived from the entity profiles, such as industry identifiers. The data aggregated by the recall data categorization engine 302 may represent, in some examples, entities involved in the supply chain of a subject contract manufacturer 112a, entities involved in the supply chain of a subject producer 112b, data associated with a certain producer 112b, data involving all producers 112b of the environment 100, data involving all contract manufacturers 112a of the environment 100, and/or data involving all supply chains 112 of the environment 100 of FIG. 1. The recall data categorization engine 302, in some examples, may be executed upon receipt of data recently uploaded to the environment 100 of FIG. 1, on a periodic basis, and/or upon request by a client of the environment 100 submitted to one of the risk management and mitigation tools 108 and/or the supplier evaluation tools 110.

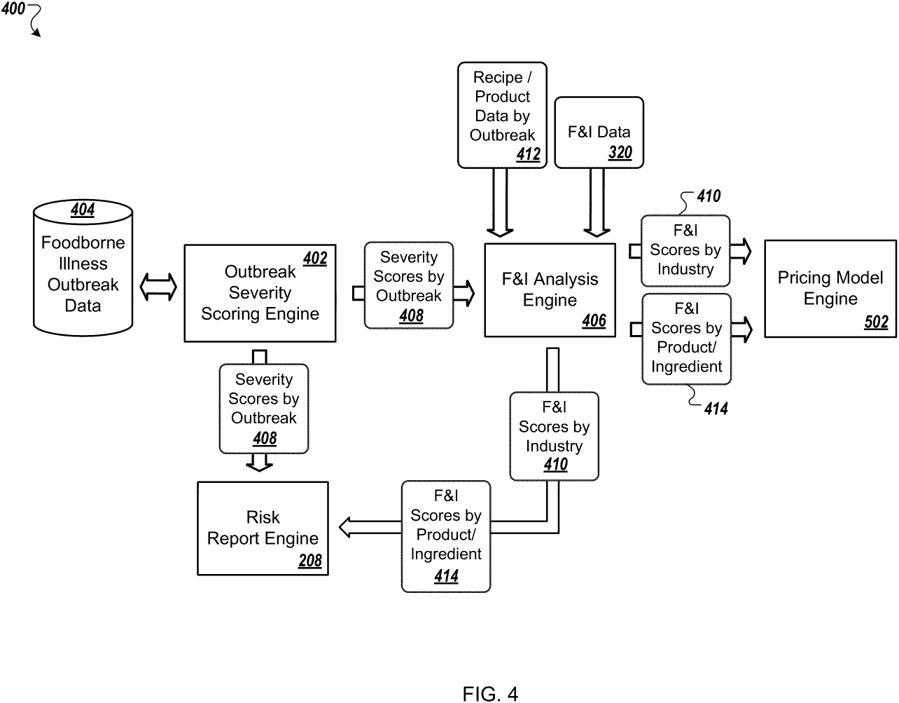

In some implementations, the recall by product data set 310, the recall by event data set 312, and the recall by reason data set 314 are accessed by a defects and contamination (D&C) scoring engine 304. The D&C scoring engine 304 may generate D&C scores 318 for use by the pricing model engine 502, described in relation to FIG. 5. The D&C scores 318, for example, may identify relative performance against other entities and/or sites evaluated by the agri-food risk tracking and management platform 102 of FIG. 1. The D&C scores 318, in some examples, may include rankings, distributions (percentiles, quartiles, etc.), variances from a median or average, variances from a target (e.g., system target or client-specified target), and/or ratings (e.g., excellent, good, standard, bad, etc.). The D&C scores 318 may be stored to the entity profiles 212 and/or site profiles 214 of the corresponding entities and/or sites. The D&C scoring engine 304 may generate food and ingredient (F&I) data 320 (e.g., scores demonstrating relative likelihood of contamination based on type of food, ingredient category, etc.) for use by a food and ingredient scoring engine 406, as discussed in relation to FIG. 4. Further, the D&C scoring engine 304 may generate D&C metrics 316 for use by the risk report engine 208 in preparing information for presentation to a user, such as a client of the agri-food risk tracking and management platform 102 of FIG. 1.

FIGS. 3B through 3D illustrate screen shots of example user interfaces for reviewing recall data metrics, such as the D&C metrics 316 of FIG. 3A. The example user interfaces, for example, may be generated by the risk report engine 208 described in relation to FIG. 2B and FIG. 3A. The risk report engine 208, for example, may translate the D&C metrics 316 into graphs, lists, and/or other analysis. The analysis may be provided in a document or email. In another example, the analysis may be provided in an interactive graphical user interface, such as a client portal to the agri-food risk tracking and management platform 102 of FIG. 1.

Turning to FIG. 3B, an example user interface 330 presenting recall information includes a number of recalls 332 (62), a number of companies affected 334 (33), an average number of products per recall (336), and a total exposure amount 338 ($84.6M). The example user interface 330 also includes a bar graph of recall classifications 340 illustrating industry deviations (e.g., across suppliers involved in the recalls) across recall classifications 342 (e.g., class I 342a, class II 342b, and class III 342c).

Turning to FIG. 3C, an example screen shot 350 illustrates industry deviations 352 broken down by recall reason 354 as well as an average product per recall 356 for each recall reason. The recalls, for example, may relate to products 112c manufactured by one or more producers 112b on behalf of one or more contract manufacturers 112a of the supply chain 112 of FIG. 1. In some examples, the screen shot 350 may represent at least a portion of producers 112b contracted by a particular contract manufacturer 112a or one or more contract manufacturers 112a included in the portfolio of a particular client 210 of FIG. 2A. The screen shot 350, for example, may have been produced by the risk report engine 208 of FIG. 2B.

The recall reasons 354, as illustrated in the screen shot 350, include undeclared major allergen 354a, extraneous material 354b, undeclared substances 354d, regulatory or mislabeling 354e, processing defect 354f, microbial contamination 354g, and other 354c. The first recall reason 354a, undeclared major allergen, is flagged with a red warning symbol 358 for a deviation greater than the industry benchmark by 20%. The warning symbol 358, for example, may flag any deviations greater than X% of an industry benchmark such as, in some examples, 10%, up to 12%, 15%, or 20% (as illustrated). The industry benchmark, in some examples, may represent all producers 112b within the platform 102, a portion of the producers 112b within a particular commodity sector (e.g., meat, eggs, & poultry, canned prepared foods, frozen prepared foods, etc.), and/or a portion of the producers 112b regulated under a particular compliance regime (e.g., USDA).

As illustrated, the industry recalls are arranged in an order of deviation from industry benchmark 352, from a largest positive deviation 352a (e.g., 20% above industry average) to a largest negative deviation 352g (e.g., 21% lower than industry average). Further, each reason for recall 354 is affiliated with an average number of products per recall 356. Next to the average number of products per recall 356, on each line, a drop-down control, when selected, presents recall details such as those illustrated in FIG. 3D,

Turning to FIG. 3D, an example screen shot 360 presents recall details related to products and suppliers within an industry (e.g., meat, eggs, and dairy). The screen shot 360 includes graphical analysis related to a number of supplier affected products 366 (206), a number of industry affected products 368 (20,177), a number of domestic regions affected 370 (50), and a number of foreign countries affected 372 (10). The screen shot 360, for example, may have been produced by the risk report engine 208 of FIG. 2B.

In some implementations, an average products per recall graph 362 presents recall counts per quarter 364b over a number of years (2011-2019) as well as an industry mean (e.g., industry standard) 364a.

In some implementations, an affected products across top 5 contamination types bar graph 374 includes numbers of affected products per contamination type (e.g., salmonella 376, listeria 377, etc.) both for the reviewing or topic supplier (e.g., a salmonella metric 376a and a listeria metric 377a) and for the all suppliers (e.g., an industry-wide average or median salmonella metric 376b and an industry-wide average or median listeria metric 377b. Although illustrated as a number of products, in other embodiments, the metrics may be presented as percentages of products. In some implementations, a top suppliers affected list 380 includes a listing of supplier names (e.g., Freshland Dairy 382a, Blackburn Steaks 382b, Rainy Day Eggs 382c). Each supplier may be individually selectable to review supplier-specific information. For example, the screen shot 360 may represent information related to a particular supplier.

FIG. 4 illustrates a flow diagram of an example process 400 for analyzing food illness outbreak data 404 and generating objective outbreak severity metrics. The food illness outbreak data 404, for example, may include recall data by classification (e.g., North American Industry Classification System (NAICS)) and/or recall data by category. The recall data categorization engine 302 of FIG. 3A, for example, may generate the outbreak data 404.

In some implementations, an outbreak severity scoring engine 402 analyzes the outbreak data 404 to determine severity scores 408. The severity scores 408, for example, may be categorized by each entity and/or site. The severity scores 408, for example, may identify relative performance against other entities and/or sites evaluated by the agri-food risk tracking and management platform 102. The severity scores 408, in some examples, may include rankings, distributions (percentiles, quartiles, etc.), variances from a median or average, variances from a target (e.g., system target or client-specified target), and/or ratings (e.g., excellent, good, standard, bad, etc.). In particular, a severity score may relate to a threshold deviation from industry benchmark 352, as described in relation to FIG. 3C. The severity scores 408 may be stored to the entity profiles 212 and/or site profiles 214 of the corresponding entities and/or sites, as described in relation to FIG. 2A.

In some embodiments, the severity scores 408 are supplied to the risk report engine 208 for generating information for review by one or more users of the agri-food risk tracking and management platform 102 of FIG. 1. The risk report engine 208, for example, may translate the severity scores 408 into graphs, lists, and/or other analysis. The analysis may be provided in a document or email. In another example, the analysis may be provided in an interactive graphical user interface, such as a client portal to the agri-food risk tracking and management platform 102 of FIG. 1.

In some implementations, the severity scores 408 are provided to a food and ingredient (F&I) analysis engine 406. The F&I analysis engine 406, additionally, accesses F&I data 320 (e.g., generated by the D&C scoring engine 304 as described in relation to FIG. 3A) and/or recipe/product data by outbreak 412. The product data, for example, may refer to a single ingredient item (e.g., frozen peas), while the recipe data may be provided when the manufactured food product is created from multiple ingredients (e.g., a cracker and cheese snack pack). The F&I Analysis engine 406, for example, may analyze the severity of the foodborne illnesses in view of ingredients and/or other food information (e.g., recipe data identifying combinations of ingredients) related to the outbreaks. The F&I analysis engine 406, as illustrated, generates F&I scores by industry data set(s) 410 as well as F&I scores by product and/or ingredient 414.

In some implementations, the F&I scores by industry data set(s) 410 and/or the F&I scores by product/ingredient data sets 414 are provided to the pricing model engine 502, described in relation to FIG. 5.

In some implementations, the F&I scores by industry data set(s) 410 and/or the F&I scores by product/ingredient data sets 414 are provided to the risk report engine 208. The F&I scores, for example, may be used in preparing the screen shot 350 of FIG. 3C. Further, the F&I scores by industry data set(s) 410 may be used in preparing a defects & contamination segment 606c of a screen shot 600 of FIG. 6A.

FIG. 5 illustrates a flow diagram of an example process 500 for applying agri-food risk analytics to agri-food contamination insurance coverage pricing. The process 500, for example, may be used to determine insurance rates for use by the risk management and mitigation tools 108 of the agri-food risk tracking and management platform 102 of FIG. 1 to mitigate supply chain risk via insurance.

In some implementations, a pricing model engine 502 accesses one or more contamination insurance pricing models 504. The contamination insurance pricing model(s) 504 may be industry applied standard pricing models and/or pricing models particular to one or more insurance clients of the agri-food risk tracking and management platform 102. The pricing models 504 can include, in some examples, general linear models (GLM), linear regression models (LRM), and/or logistic regression models. Further, the pricing models may include tiered pricing models. The pricing models 504, in some examples, may include premiums, purchase limits, deductibles, and/or self-insured retentions (SIRs) representing industry pricing for insurance policies directed to mitigating supplier chain risks such as foodborne illness outbreaks, spoilage, product recalls, and other adverse events.

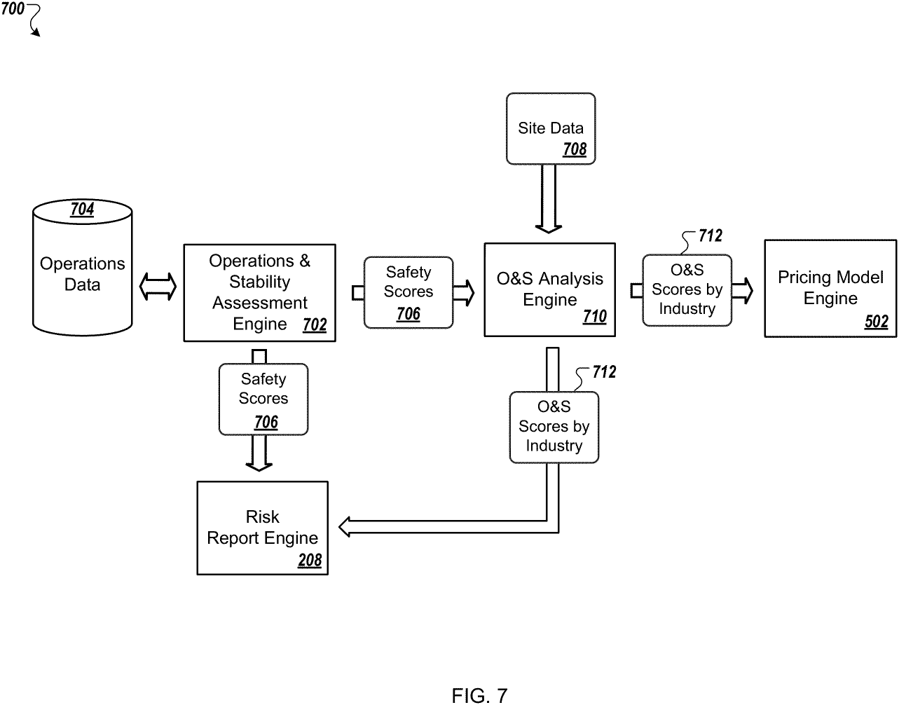

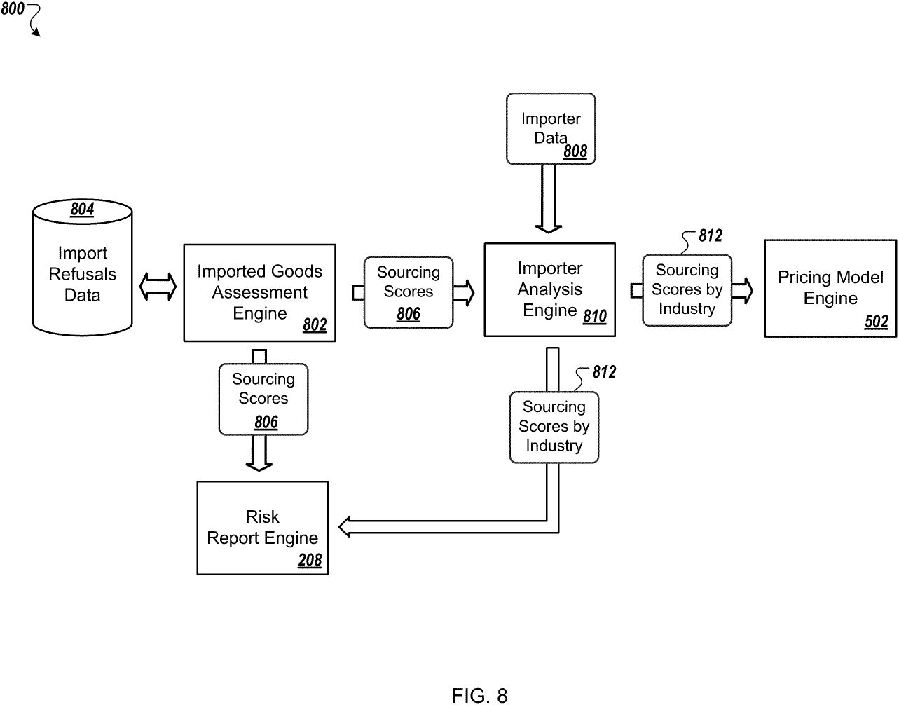

The pricing model engine 502, in some implementations, analyzes the inspection rate by entity data set 222 and the compliance actions by entity data set 230 of FIG. 2A, the G&C score by entity data set 240 of FIG. 2B, the D&C score by entity data set 318 of FIG. 3A to factor supplier risks and supply chain risks into pricing models 504. Further, in some implementations, the pricing model engine 502 analyzes industry-specific risk information, such as, in some examples, the F&I score by industry data set 410 of FIG. 4, an operations & stability score by industry data set 712 of FIG. 7, and/or a sourcing score by industry data set 812 of FIG. 8 to generate pricing models adjusted by industry-inherent risk factors. The pricing model engine 502, in some embodiments, applies the industry risk, supplier risk and/or supply chain risk analysis to the pricing models 504 to produce risk score-enhanced pricing model data 506.

FIG. 6A illustrates a screen shot of an example user interface 600 for reviewing risk aspects of a supplier in view of industry benchmarks and target levels of risk exposure. The supplier, for example, may include one of the contract manufacturers 112a and/or producers 112b as described in relation to FIG. 1. The user interface 600 presents overview analysis related a segments 606 of analysis provided by the agri-food risk tracking and management platform 102, such as a governance & compliance segment 606a (e.g., analyzed using the process 200 of FIG. 2A and FIG. 2B), a products segment 606b (e.g., analyzed using the process 400 of FIG. 4), a defects & contamination segment 606c (e.g., analyzed using the process 300 of FIG. 3A and/or the process 400 of FIG. 4), a sourcing segment 606d, an operations & stability segment 606e (e.g., analyzed using the process 700 of FIG. 7), and a contamination insurance segment 606f (e.g., supported by the process 500 of FIG. 5). Each of the segments 606 are analyzed in view of a target state 602, and an industry benchmark 604. An overall score 608 per segment 606 is also presented.

FIG. 6B illustrates a flow chart of an example method 650 for identifying supplier peers and preparing a peer risk comparison of agri-food risk metrics. The method 650, for example, may be applied by the agri-food risk tracking and management platform 102 of FIG. 1 for presenting supplier evaluations 110 in view of the industry and/or peer suppliers.

In some implementations, the method 650 begins with determining supplier characteristics of a subject supplier (652). The characteristics, in some examples, can include a type of supplier, a size of supplier, a geographic region of the supplier, a type of foods and/or ingredients handled by the supplier, and/or a governmental inspection regimen applicable to the subject supplier.

In some implementations, peer suppliers to the subject supplier are identified using the characteristics (654). The peers, for example, may be additional members of the agri-food risk tracking and management platform 102 of FIG. 1, such as the contract manufacturers 112a and/or producers 112b. The peer suppliers may be identified based upon closest similarity to the subject supplier.

In some implementations, a set of risk scores corresponding to the peer suppliers is obtained (656). The risk scores, in some examples, may include the G&C scores 236 of FIG. 2B, the D&C scores 318 of FIG. 3A, the severity scores 408 of FIG. 4, the F&I scores 410 of FIG. 4, the safety scores 706 of FIG. 7, and/or the sourcing scores 806 of FIG. 8. The set of risk scores, for example, may have been calculated by the risk identification engine 106 and/or the risk management and mitigation tools 108 of FIG. 1.

In some implementations, if risk information is incomplete for the subject supplier (658) one or more risk scores corresponding to the subject supplier may be predicted based on the peer supplier risk scores (660). The predicted score(s), for example, may be calculated using an average score, mean score, weighted average score, or other combination of peer supplier risk scores. Further, the predicted score(s) may be based a subset of the peer suppliers (e.g., peer suppliers closest in similarity to the subject supplier) and/or a portion of the peer supplier data (e.g., most recent data, data corresponding to timeframe where peer supplier most closely matched the subject supplier, etc.).

In some implementations, for each risk score of a set of risk scores, one or more benchmark metrics are determined for the subject supplier relative to the peer suppliers (662). The benchmark metrics, for example, may include one or more of the industry benchmarks 604a-604f of FIG. 6A. Further, the benchmark metrics may include industry citation/inspection classification metrics such as those represented in FIGS. 2C and 2D, industry norms in inspection rates as shown in FIG. 2D, recall classifications, numbers of products involved, and total exposure metrics as presented in FIG. 3B, recall benchmarks such as recall per reason as shown in FIG. 3C, and/or average products per recall as shown in FIG. 3D. The benchmark metrics, in some embodiments, are generated per industry and per risk score category (e.g., the categories 606a-606f of FIG. 6A).

In some implementations, a benchmark analysis is presented to a user (664). The benchmark analysis, for example, can include graphics similar to those illustrated in relation to FIG. 6A, FIG. 2C, FIG. 2D, FIG. 3B, FIG. 3C, and/or FIG. 3D. The benchmark analysis, for example, may be presented as an interactive report available to the user from a platform dashboard interface.

FIG. 7 is a flow diagram of an example process 700 for analyzing operations data and generating objective operations safety and stability metrics. The process 700, for example, may be performed by the risk data aggregation engine 104 of FIG. 1.

In some implementations, an operations & stability assessment engine 702 processes operations data 704 (e.g., the regulatory data 128 and/or 132 as described in relation to FIG. 1) to derive safety scores 706 for producers and/or manufacturers (e.g., the producers 112b and/or manufacturers 112a of FIG. 1). The safety scores 706, for example, may be developed using public data such as, in an illustrative example, OSHA public data. The public data may be available as a set of individual records related to each producer and/or manufacturer such that the public data provides no meaningful way to discover behavioral trends or interpret relative success or failure of individual producers and/or manufacturers in complying with safety regulations. The operations & stability assessment engine 702 may aggregate operations data 704 across individual producers and/or manufacturers based on a number of categories such as, in some examples, types of violations, gravity of violations, timeframe of violations (e.g., month, quarter, year, etc.). The operations & stability assessment engine 702 may weight certain operations data 704 when deriving the safety scores 706, such that more serious and/or repeated violations create a more significant impact on the safety scores 706 than less critical violations, such as administrative errors.

In some implementations, the safety scores 706 are accessed by the risk report engine 208 of FIG. 2B to incorporate the safety scores 706 into reports detailing safety information regarding the manufacturers and/or producers. The safety score 706 of an individual producer or manufacturer may be included, for example, as the operations & stability score 608e of FIG. 6A in a graphical analysis output of a risk report.

In some implementations, an operations & stability analysis engine 710 accesses the safety scores 706 as well as site data 708 related to each producer and/or manufacturer to create operations & stability scores by industry 712. The site data 708, for example, may be provided by users of the agri-food risk tracking and management platform 102, detailing supply chain information (e.g., particular contract manufacturers 112a and producers 112b). The site data 708, in some examples, may include information regarding each supplier within a user’s supply chain(s) (e.g., name, incorporation, registrations, licenses, capacity, product type(s), etc.), as well as site information (e.g., a number of sites, the addresses (or partial addresses) of locations of sites, product type(s) per site, capacity per site, etc.).

In some implementations, using the site data 708, the operations & stability analysis engine 710 aggregates safety scores 706 to calculate operations & stability scores by industry 712. The operations & stability scores by industry 712, in some examples, can include industry median scores, industry average scores, industry quartile scores, and/or industry top N% average scores (e.g., average of top 10% of the industry, average of top 5% of the industry). Further, the operations & stability scores by industry 712 may be generated based on geographic location, capacity, size of organization, maturity of organization, and/or other categorizations of the manufacturers and/or producers. The O&S scores by industry 712, for example, may be used by the risk report engine 208 to present the O&S industry benchmark score 604e of FIG. 6A.

In some implementations, the operations & stability scores by industry 712 are provided to the pricing model engine 502 of FIG. 5 to factor operations & stability industry norms into insurance pricing models.

Turning to FIG. 8, a flow diagram of an example process 800 for analyzing import refusals data and generating objective imported goods and importer reliability metrics is provided. The process 800, for example, may be performed by the risk data aggregation engine 104 of FIG. 1.

In some implementations, the process 800 begins with an imported goods assessment engine 802 obtaining import refusals data 804 from one or more public sources. The supplier data 136 of FIG. 1, for example, may include the import refusals data 804. The import refusals data 804, for example, may be obtained from FDA public documents. The public data may be available as a set of individual records related to each importer such that the public data provides no meaningful way to discover behavioral trends or interpret relative success or failure of individual importers in complying with import regulations. The imported goods assessment engine 802 may aggregate the import refusals data 804 across individual importers based on categories such as, in some examples, types of refusals (e.g., mislabeling, goods have no FDA approval, etc.), gravity of refusals, and/or timeframe of refusals (e.g., month, quarter, year, etc.) to produce sourcing scores 806. The imported goods assessment engine 802 may weight certain import refusals data 804 when deriving the sourcing scores 806, such that more serious and/or repeated non-compliance problems create a more significant impact on the sourcing scores 806 than less critical refusals, such as minor mislabeling issues.

In some implementations, the sourcing scores 806 are accessed by the risk report engine 208 of FIG. 2B to incorporate the sourcing scores 806 into reports detailing risk information regarding importers. The sourcing scores 806 of an individual importer or group of importers may be included, for example, as the sourcing score 608d of FIG. 6A in a graphical analysis output of a risk report.

In some implementations, an importer analysis engine 810 accesses the sourcing scores 806 as well as importer data 808 related to each importer to create sourcing scores by industry 812. The importer data 808, for example, may be provided by users of the agri-food risk tracking and management platform 102 of FIG. 1, detailing supply chain information (e.g., importers used by the contract manufacturers 112a and/or the producers 112b). The importers, in another example, may import a portion of the products 112c of FIG. 1. The importer data 808 may include information regarding each importer within a user’s supply chain(s). The importer data 808, in some examples, may include importer name, incorporation, registrations, licenses, regions, address, port(s) of export, and/or product type(s) imported.

In some implementations, using the importer data 808, the importer analysis engine 810 aggregates the sourcing scores 806 to calculate sourcing scores by industry 812. The sourcing scores by industry 812, in some examples, can include industry median scores, industry average scores, industry quartile scores, and/or industry top N% average scores (e.g., average of top 10% of the industry, average of top 5% of the industry). Further, the sourcing scores by industry 812 may be generated based on geographic location, type of product(s), and/or shipment mode of product(s) (e.g., overland trailer, air delivery, ocean vessel, etc.). The sourcing scores by industry 812, for example, may be used by the risk report engine 208 of FIG. 2B to present the sourcing industry benchmark score 604d of FIG. 6A.

In some implementations, the sourcing scores by industry 812 are provided to the pricing model engine 502 of FIG. 5 to factor sourcing industry norms into insurance pricing models. Reference has been made to illustrations representing methods and systems according to implementations of this disclosure. Aspects thereof may be implemented by computer program instructions. These computer program instructions may be provided to a processor of a general-purpose computer, special purpose computer, or other programmable data processing apparatus and/or distributed processing systems having processing circuitry, such that the instructions, which execute via the processor of the computer or other programmable data processing apparatus, create means for implementing the functions/operations specified in the illustrations.

One or more processors can be utilized to implement various functions and/or algorithms described herein. Additionally, any functions and/or algorithms described herein can be performed upon one or more virtual processors. The virtual processors, for example, may be part of one or more physical computing systems such as a computer farm or a cloud drive.

Aspects of the present disclosure may be implemented by software logic, including machine readable instructions or commands for execution via processing circuitry. The software logic may also be referred to, in some examples, as machine readable code, software code, or programming instructions. The software logic, in certain embodiments, may be coded in runtime-executable commands and/or compiled as a machine-executable program or file. The software logic may be programmed in and/or compiled into a variety of coding languages or formats.

Aspects of the present disclosure may be implemented by hardware logic (where hardware logic naturally also includes any necessary signal wiring, memory elements and such), with such hardware logic able to operate without active software involvement beyond initial system configuration and any subsequent system reconfigurations (e.g., for different object schema dimensions). The hardware logic may be synthesized on a reprogrammable computing chip such as a field programmable gate array (FPGA) or other reconfigurable logic device. In addition, the hardware logic may be hard coded onto a custom microchip, such as an application-specific integrated circuit (ASIC). In other embodiments, software, stored as instructions to a non-transitory computer-readable medium such as a memory device, on-chip integrated memory unit, or other non-transitory computer-readable storage, may be used to perform at least portions of the herein described functionality.

Various aspects of the embodiments disclosed herein are performed on one or more computing devices, such as a laptop computer, tablet computer, mobile phone or other handheld computing device, or one or more servers. Such computing devices include processing circuitry embodied in one or more processors or logic chips, such as a central processing unit (CPU), graphics processing unit (GPU), field programmable gate array (FPGA), application-specific integrated circuit (ASIC), or programmable logic device (PLD). Further, the processing circuitry may be implemented as multiple processors cooperatively working in concert (e.g., in parallel) to perform the instructions of the inventive processes described above.

The process data and instructions used to perform various methods and algorithms derived herein may be stored in non-transitory (i.e., non-volatile) computer-readable medium or memory. The claimed advancements are not limited by the form of the computer-readable media on which the instructions of the inventive processes are stored. For example, the instructions may be stored on CDs, DVDs, in FLASH memory, RAM, ROM, PROM, EPROM, EEPROM, hard disk or any other information processing device with which the computing device communicates, such as a server or computer. The processing circuitry and stored instructions may enable the computing device to perform, in some examples, the process 200 of FIGS. 2A and 2B, the process 300 of FIG. 3A, the process 400 of FIG. 4, the process 500 of FIG. 5, the method 650 of FIG. 6B, the process 700 of FIG. 7, and/or the process 800 of FIG. 8.

These computer program instructions can direct a computing device or other programmable data processing apparatus to function in a particular manner, such that the instructions stored in the computer-readable medium produce an article of manufacture including instruction means which implement the function/operation specified in the illustrated process flows.

Embodiments of the present description rely on network communications. As can be appreciated, the network can be a public network, such as the Internet, or a private network such as a local area network (LAN) or wide area network (WAN) network, or any combination thereof and can also include PSTN or ISDN sub-networks. The network can also be wired, such as an Ethernet network, and/or can be wireless such as a cellular network including EDGE, 3G, 4G, and 5G wireless cellular systems. The wireless network can also include Wi-Fi®, Bluetooth®, Zigbee®, or another wireless form of communication. The network, for example, may support communications between the agri-food risk tracking and management platform 102 of FIG. 1 and any of the contract manufacturers 112a, the producers 112b, the retailers 112d, the public health tracking system 138, the ingredient import tracking system 134, the domestic ingredient production compliance and inspection system 130, the food producer regulatory compliance and inspection system 126, and the food data standards system 122. Further, the network may support communications between components of the agri-food risk tracking and management platform 102, such as the various engines described in relation to FIGS. 2A and 2B, FIG. 3A, FIG. 4, FIG. 5, FIG. 7, and FIG. 8. The computing device, in some embodiments, further includes a display controller for interfacing with a display, such as a built-in display or LCD monitor. A general purpose I/O interface of the computing device may interface with a keyboard, a hand-manipulated movement tracked I/O device (e.g., mouse, virtual reality glove, trackball, joystick, etc.), and/or touch screen panel or touch pad on or separate from the display. The display controller and display may enable presentation of the screen shots illustrated, in some examples, in FIG. 2C, FIG. 2D, FIGS. 3B-3D, and FIG. 6A.

Moreover, the present disclosure is not limited to the specific circuit elements described herein, nor is the present disclosure limited to the specific sizing and classification of these elements. For example, the skilled artisan will appreciate that the circuitry described herein may be adapted based on changes in battery sizing and chemistry or based on the requirements of the intended back-up load to be powered.

The functions and features described herein may also be executed by various distributed components of a system. For example, one or more processors may execute these system functions, where the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system, in some examples, may be received via direct user input and/or received remotely either in real-time or as a batch process.

Although provided for context, in other implementations, methods and logic flows described herein may be performed on modules or hardware not identical to those described. Accordingly, other implementations are within the scope that may be claimed.

In some implementations, a cloud computing environment, such as Google Cloud Platform™ or Amazon™ Web Services (AWS™), may be used perform at least portions of methods or algorithms detailed above. The processes associated with the methods described herein can be executed on a computation processor of a data center. The data center, for example, can also include an application processor that can be used as the interface with the systems described herein to receive data and output corresponding information. The cloud computing environment may also include one or more databases or other data storage, such as cloud storage and a query database. In some implementations, the cloud storage database, such as the Google™ Cloud Storage or Amazon™ Elastic File System (EFS™), may store processed and unprocessed data supplied by systems described herein. For example, the contents of the data stores 114, 116, 118, 120, 124, 128, 132, 136, and/or 140 of FIG. 1, the contents of the inspection data 216, citation data 218, compliance data 220, client profiles 210, and/or entity profiles 212 of FIG. 2A and FIG. 2B, the contents of the site profiles 214 of FIG. 2B, the contents of the recall data 306 of FIG. 3A, the contents of the food illness outbreak data 404 of FIG. 4, the contents of the pricing models 504 and/or the risk score enhanced price model data 506 of FIG. 5, the contents of the operations data 704 and/or the site data 708 of FIG. 7, and/or the contents of the import refusals data 804 and/or the importer data 808 of FIG. 8 may be maintained in a database structure.

The systems described herein may communicate with the cloud computing environment through a secure gateway. In some implementations, the secure gateway includes a database querying interface, such as the Google BigQuery™ platform or Amazon RDS™. The data querying interface, for example, may support access by one or more engines of the agri-food risk tracking and management platform 102, such as the risk data aggregation engine 104, the governance & compliance data aggregation engine 202 of FIG. 2A, the recall data categorization engine 302 of FIG. 3A, the outbreak severity scoring engine 402 of FIG. 4, the pricing model engine 502 of FIG. 5, the operations & stability assessment engine 702 of FIG. 7, and/or the imported goods assessment engine 802 of FIG. 8.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. A system for evaluating risk in a food supply chain, the system comprising:
a non-transitory computer readable entity data store configured to maintain risk data regarding a plurality of entities involved in a plurality of food supply chains;
a non-transitory computer readable client data store configured to maintain food supply chain data regarding the plurality of food supply chains, each food supply chain associated with at least one client of a plurality of clients; and
software logic for executing on processing circuitry and/or hardware logic configured to perform operations comprising
collecting, from a plurality of external computing systems via a network, food producer regulatory data for the plurality of entities, wherein the food producer regulatory data comprises records associated with i) a plurality of inspections, and at least one of ii) a plurality of citations or iii) a plurality of noncompliance indications,
organizing, for storage to the non-transitory computer readable entity data store, the food producer regulatory data as the risk data comprising a plurality of risk data records associated with each entity of the plurality of entities,
classifying, for each entity of the plurality of entities, respective risk data records to obtain sets of classification data by entity, wherein the plurality of risk data records are classified according to a set of risk classifications, wherein the set of risk classifications comprises one or more of inspection outcomes, citation types, citation severities, or outbreak frequencies,
analyzing the respective risk data records of at least a portion of a plurality of entities to determine, for each respective risk classification of the set of risk classifications, at least one standard value associated with the respective risk classification,
identifying, in view of a predetermined client of the plurality of clients, a set of entities corresponding to one or more food supply chains of the plurality of food supply chains associated with the predetermined client,
analyzing, in view of the at least one standard value associated with each risk classification of the set of risk classifications, the sets of classification data associated with each entity of the set of entities to calculate at least one classification score, and
preparing, for presentation to a user at a remote computing device, an interactive report presenting a comparison in risk outcome of the set of entities to at least one standard outcome defined based on the at least one standard value associated with each risk classification of the set of risk classifications.

2. The system of claim 1, wherein the software logic for executing on processing circuitry and/or the hardware logic are configured to perform operations comprising selecting the portion of the plurality of entities based on an industry of the one or more food supply chains.

3. The system of claim 1, wherein the at least one standard value comprises a lower end of a range of values, an upper end of a range of values, and at least one of an average value or a median value.

4. The system of claim 1, wherein:
the set of risk classifications comprises a recall classification; and
the at least one standard value associated with the recall classification comprises at least one of an average number of products per recall, a median number of products per recall, an average number of recalls per time period, or a median number of recalls per time period.

5. The system of claim 4, wherein the at least one standard value associated with the recall classification comprises at least one standard value corresponding to each reason of a plurality of reasons for recall.

6. The system of claim 1, wherein the at least one classification score comprises a percentage deviation from a corresponding average or median value.

7. The system of claim 1, wherein the plurality of entities comprises a plurality of food suppliers and a plurality of food manufacturers.

8. The system of claim 1, wherein the plurality of entities comprises a plurality of food importers.

9. The system of claim 1, wherein the interactive report comprises a historic analysis comparing risk outcome of at least one entity of the set of entities across a plurality of years.

10. The system of claim 1, wherein:
the software logic for executing on processing circuitry and/or the hardware logic are configured to perform operations comprising ranking, by the at least one classification score, the set of entities; and
the interactive report comprises identification of top two or more suppliers based on the at least one classification score.

11. The system of claim 10, wherein the top two or more suppliers represent worst score values of the at least one classification score among the set of entities.

12. A method for quantifying risk in a food supply chain, the method comprising:
collecting, from a plurality of external computing systems via a network, risk data for a plurality of suppliers, wherein the risk data comprises records associated with a) regulatory compliance, b) production inspection outcome, and c) product inspection outcome;
organizing, for storage to a non-transitory computer readable data store, the risk data as a plurality of risk data records associated with each respective supplier of the plurality of suppliers, wherein
the plurality of risk data records form a portion of a supplier profile of the respective supplier, and
the supplier profile comprises a set of characteristics of the respective supplier;
identifying, out of the plurality of suppliers, a set of peer suppliers to a predetermined supplier using the set of characteristics of the predetermined supplier;
analyzing the respective risk data records of the set of peer suppliers to determine at least one regulatory compliance benchmark score, at least one production inspection benchmark score, and at least one product inspection benchmark score;
analyzing the respective risk data records of the predetermined supplier to determine at least one regulatory compliance risk score, at least one production inspection risk score, at least one product inspection risk score, and an overall risk score; and
preparing, for presentation to a user at a remote computing device, an interactive report presenting a benchmark analysis of the predetermined supplier comprising a visual comparison of the at least one regulatory compliance risk score to the at least one regulatory compliance benchmark score, a visual comparison of the at least one production inspection risk score to the at least one production inspection benchmark score, and a visual comparison of the at least one product inspection risk score to the at least one product inspection benchmark score.

13. The method of claim 12, wherein the set of characteristics of the respective supplier comprises one or more of: a type of supplier, a size of supplier, a geographic region of the supplier, one or more type of foods handled by the supplier, one or more types of ingredients handled by the supplier, or a governmental inspection regimen applicable to the supplier.

14. The method of claim 12, wherein determining one or more of the at least one regulatory compliance risk score, the at least one production inspection risk score, or the at least one product inspection risk score comprises:
identifying the plurality of risk data records associated with the predetermined supplier is missing or incomplete;
obtaining a plurality of peer risk scores comprising, for each respective peer supplier of the set of peer suppliers, one or more peer risk scores corresponding to the missing or incomplete risk data records; and
using the plurality of peer risk scores, calculating the one or more of the at least one regulatory compliance risk score, the at least one production inspection risk score, or the at least one product inspection risk score as one or more predicted risk scores.

15. The method of claim 12, wherein collecting the risk data further comprises collecting operations data, the method comprising:
analyzing the respective risk data records of the set of peer suppliers to determine at least one operations safety benchmark score; and
analyzing the respective risk data records of the predetermined supplier to determine at least one operations safety score;
wherein the interactive report further comprises a visual comparison of the at least one operations safety score to the at least one operations safety benchmark score.

16. The method of claim 15, wherein determining the at least one operations safety score comprises calculating a weighted score based on significance of each violation and/or a number of repeated violations.

17. The method of claim 12, wherein collecting the risk data further comprises collecting import refusals data, the method comprising:
analyzing the respective risk data records of the set of peer suppliers to determine at least one sourcing benchmark score; and
analyzing the respective risk data records of the predetermined supplier to determine at least one sourcing score;
wherein the interactive report further comprises a visual comparison of the at least one sourcing score to the at least one sourcing benchmark score.

18. The method of claim 17, wherein determining the at least one sourcing score comprising calculating a weighted score based on a significance of each import refusal and/or a number of repeated import refusals.

19. A system for mitigating risk in a food supply chain, the system comprising: software logic for executing on processing circuitry and/or hardware logic configured to perform operations comprising
aggregating, based on a set of suppliers of a food product, supplier risk data, the supplier risk data comprising food product information and governance and compliance information, wherein
the food product information comprises ingredient information, and wherein
the governance and compliance information comprises one or more of inspection information, citation information, or compliance information for each supplier of the set of suppliers;
identifying, by a set of trained machine learning data models, one or more ingredient risk factors for one or more food product ingredients, wherein
the set of trained machine learning data models are trained with corresponding industry food data for a period of two or more successive years, wherein the industry food data represents a plurality of suppliers of food products within a same industry as the food product, and
the one or more ingredient risk factors correspond to attributes of the industry food data in a first year of the two or more successive years that predict future food born illness from the industry food data in at least one next year of the two or more successive years;
determining a governance and compliance score representing relative performance of the set of suppliers in view of historical performance data of the plurality of suppliers; and
preparing, for presentation to a user at a remote computing device, an interactive report presenting information regarding the one or more ingredient risk factors and the governance and compliance score.
